(19) United States
(12) Patent Application Publication
(10) Pub. No.: US 2007/0237884 A1
(43) Pub. Date: Oct. 11, 2007

(54) Banana pepper salsa

(76) Inventor: James C. Underwood, Boones Mill, VA (US)

Correspondence Address: JAMES RAY & ASSOCIATES, 2640 PITCAIRN ROAD, MONROEVILLE, PA, 15146, US

(21) Appl. No.: 11/784,019

(22) Filed: Apr. 5, 2007

Related U.S. Application Data
(60) Provisional application No. 60/790,906, filed on Apr. 10, 2006.

(51) Int. Cl. A23L 1/221

(52) U.S. Cl. 426/650

(57) ABSTRACT

A banana pepper salsa formulation comprises banana peppers being present in the formulation in a concentration of between about 35 and about 38 percent by weight. Chopped onions are present in the salsa formulation in a concentration of between about 1.8 and about 2.6 per cent by weight. Vegetable oil and apple cider vinegar are each present in the salsa formulation in a concentration of between about 4 and about 5 per cent by weight. Chopped garlic is present in the salsa formulation in a concentration of between about 1.0 and about 1.3 per cent by weight. Cilantro is present in the salsa formulation in a concentration of between about 1.5 and about 1.9 per cent by weight. Garlic powder, celery seed and onion powder are each present in the salsa formulation in a concentration of between about 0.05 and about 0.09 per cent by weight. Regular table salt is present in the salsa blend in a concentration of between about 0.40 and about 0.49 per cent by weight, and ketchup is present in the salsa formulation in a concentration of between about 47 and about 49.5 per cent by weight.

### CROSS REFERENCE TO RELATED APPLICATIONS

This application is closely related to and claims benefit from U.S. Provisional Application Ser. No. 60/790,906 filed Apr. 10, 2006.

### FIELD OF THE INVENTION

The present invention relates, in general, to a salsa, and, more particularly, the present invention relates to a recipe and a method of making a mild and a hot spicy salsa.

### BACKGROUND OF THE INVENTION

In today's market salsa blends are an ever increasingly popular food item. Every year it seems that the popularity of these items is growing at a very rapid rate. There are a variety of such salsa mixes on the market today that cater to wide variety of tastes. Some of the chain Mexican style restaurants not only have their own salsa blend in their restaurants but have a product hat is marketed in many supermarkets to go along with the other salsa blends that have been on the market for years.

As the taste for Mexican style food products which has been very popular in the southwestern parts of the United States and in recent years is finding continual growth and popularity of these products in other parts of the country there is a continually increased market for these items and salsa is one of the biggest of these items. Further, the increased consumption of such items as tortilla and nacho chips further increases the market for different varieties of salsa.

Most of the salsa that is presently found on the shelf at local supermarkets are most likely a watered down artificial tasting mixture of bland ingredients. The so-called flavors and intensities leave much to the imagination. Hot and spicy food lovers are always seeking the next hot commodity. Thus, it would be advantageous if there were a product on the market that could accommodate the taste of such hot salsa lovers.

### SUMMARY OF THE INVENTION

The present invention provides a banana pepper salsa formulation. The formulation comprises banana peppers being present in said banana pepper formulation in a concentration of between about 35 and about 38 percent by weight. Chopped onions are present in the salsa formulation in a concentration of between about 1.8 and about 2.6 per cent by weight. Vegetable oil is present in the salsa formulation in a concentration of between about 4 and about 5 per cent by weight. Apple cider vinegar is present in the salsa formulation in a concentration of between about 4 and about 5 per cent by weight. Chopped garlic is present in the salsa formulation in a concentration of between about 1.0 and about 1.3 per cent by weight. Cilantro is present in the salsa formulation in a concentration of between about 1.5 and about 1.9 per cent by weight. Garlic powder, celery seed and onion powder are each present in the salsa formulation in a concentration of between about 0.05 and about 0.09 per cent by weight. Regular table salt is present in the salsa blend in a concentration of between about 0.40 and about 0.49 per cent by weight, and ketchup is present in the salsa formulation in a concentration of between about 47 and about 49.5 per cent by weight.

In a second aspect the present invention provides a method for preparing a hot banana pepper salsa. The method comprises the steps of selecting hot banana peppers before they have turned red. The next steps are washing predetermined amount of the hot banana peppers selected previously and then drying the hot banana peppers washed in a previous step. Next is selecting a predetermined amount of onions, garlic and cilantro for the salsa and then chopping the washed and dried banana peppers, the onions, the garlic and the cilantro selected previously into pieces having a predetermined size. The next step involves placing a predetermined amount of oil into a large pot and then adding a predetermined amount of ketchup to the pot. The mixture in the pot is mixed until the mixture is thoroughly blended. A predetermined amount of vinegar is added to the pot. The mixture in the pot is stirred frequently. Preselected spices are added to the mixture in the pot. The next step involves heating the mixture in the pot to a temperature of between 150 and 175 degrees Fahrenheit. Then the onions, garlic and cilantro that were previously chopped are added into the pot. The chopped banana peppers are then added to the pot and the contents of the pot are brought to a slow boil, being very sure not to over cook the mixture. A predetermined amount of salt is then added to the mixture. The mixture is stirred frequently until the mixture is brought to a slow boil. The pot is then removed from the heat source and the salsa blend is placed into heated jars for canning. The jars are then sealed with the salsa inside and then allowed to cool.

### OBJECTS OF THE INVENTION

It is, therefore, one of the primary objects of the present invention to provide a hot salsa which is prepared for spicy salsa lover's taste.

Another object of the present invention to provide a salsa which contains hot banana peppers.

Still another object of the present invention to provide a salsa which can be made which also contains other banana peppers.

Yet another object of the present invention to provide a salsa blend which can be made in a mild variety also.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE PRESENTLY PREFERRED AND VARIOUS ALTERNATIVE EMBODIMENTS OF THE INVENTION

The present invention, in one embodiment, provides the composition in making a hot salsa blend which is a banana pepper salsa formulation. The formulation comprises banana peppers being present in said banana pepper formulation in a concentration of between about 35 and about 38 percent by weight. Chopped onions are present in the salsa formulation in a concentration of between about 1.8 and about 2.6 per cent by weight. Vegetable oil is present in the salsa formulation in a concentration of between about 4 and about 5 per cent by weight. Apple cider vinegar is present in the salsa formulation in a concentration of between about 4 and about 5 per cent by weight. Chopped garlic is present in the salsa formulation in a concentration of between about 1.0 and about 1.3 per cent by weight. Cilantro is present in the salsa formulation in a concentration of between about 1.5 and about 1.9 per cent by weight. Garlic powder, celery seed and onion powder are each present in the salsa formulation in a concentration of between about 0.05 and about 0.09 per cent by weight. Regular table salt is present in the salsa blend in a concentration of between about 0.40 and about 0.49 per cent by weight, and ketchup is present in the salsa formulation in a concentration of between about 47 and about 49.5 per cent by weight.

The banana peppers according to a preferred embodiment are hot banana peppers. In the formulation discussed supra where only hot banana peppers are used provides for a hot, spicy salsa blend.

In an alternate embodiment all of the banana peppers are not hot. In this embodiment designed to make a mild salsa, hot banana peppers are present in a concentration of between about 20 and 21 percent by weight. The formulation further includes sweet banana peppers that are present in a concentration of between about and 15 and 17 per cent by weight. The remaining ingredients are the same as discussed previously and the total amount of banana peppers are substantially the same. The only difference is that in the hot salsa blend only hot banana peppers are used wherein in the mild blend there is a mixture of hot and sweet banana peppers.

In the hot salsa blend it is presently preferred that such concentration of hot banana peppers in the formulation are in a concentration of between about 36.25 and 37.25 per cent by weight. Also the ketchup is present in the formulation in a concentration of between about 47.5 and 48.7 per cent by weight.

It is presently preferred that such apple cider vinegar and such vegetable oil are each present in the formulation in a concentration of between about 4.25 and 4.75 percent by weight. It is preferred that such vegetable oil is corn oil or canola oil and even more preferred that such oil is canola.

In a second aspect the present invention provides a method for preparing a hot banana pepper salsa. The method comprises the steps of selecting hot banana peppers before they have turned red. The next steps are washing predetermined amount of the hot banana peppers selected previously and then drying the hot banana peppers washed in a previous step. Next is selecting a predetermined amount of onions, garlic and cilantro for the salsa and then chopping the washed and dried banana peppers, the onions, the garlic and the cilantro selected previously into pieces having a predetermined size. The next step involves placing a predetermined amount of oil into a large pot and then adding a predetermined amount of ketchup to the pot. The mixture in the pot is mixed until the mixture is thoroughly blended. A predetermined amount of vinegar is added to the pot. The mixture in the pot is stirred frequently. Preselected spices are added to the mixture in the pot. The next step involves heating the mixture in the pot to a temperature of between 150 and 175 degrees Fahrenheit. Then the onions, garlic and cilantro that were previously chopped are added into the pot. The chopped banana peppers are then added to the pot and the contents of the pot are brought to a slow boil, being very sure not to over cook the mixture. A predetermined amount of salt is then added to the mixture. The mixture is stirred frequently until the mixture is brought to a slow boil. The pot is then removed from the heat source and the salsa blend is placed into heated jars for canning. The jars are then sealed with the salsa inside and then allowed to cool.

Again the above method is for making a hot salsa blend. However, the steps to make a mild salsa blend are essentially the same. The only difference is that instead of using only hot banana peppers as is done for the hot blend, a mixture of hot banana peppers and sweet banana peppers are used. But the steps in the procedure are the same.

It must be emphasized that one must be careful not to overheat the mixture once all of the main ingredients are added and the mixture is brought to a slow boil. This is very important.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. A banana pepper salsa formulation comprising:
(a) banana peppers being present in said banana pepper formulation in a concentration of between about 35 and about 38 percent by weight;
(b) chopped onions being present in said salsa formulation in a concentration of between about 1.8 and about 2.6 per cent by weight;
(c) vegetable oil being present in said salsa formulation in a concentration of between about 4 and about 5 per cent by weight;
(d) apple cider vinegar being present in said salsa formulation in a concentration of between about 4 and about 5 per cent by weight;
(e) chopped garlic being present in said salsa formulation in a concentration of between about 1.0 and about 1.3 per cent by weight;
(f) cilantro being present in said salsa formulation in a concentration of between about 1.5 and about 1.9 per cent by weight;
(g) garlic powder being present in said salsa formulation in a concentration of between about 0.05 and about 0.09 per cent by weight;
(h) celery seed being present in said salsa formulation in a concentration of between about 0.05 and about 0.09 per cent by weight;
(i) onion powder being present in said salsa formulation in a concentration of between about 0.05 and about 0.09 per cent by weight;
(j) salt being present in said salsa formulation in a concentration of between about 0.40 and about 0.49 per cent by weight; and
(k) ketchup being present in said salsa formulation in a concentration of between about 47 and about 49.5 per cent by weight.

2. The formulation, according to claim 1, wherein said banana peppers are hot banana peppers.

3. The formulation, according to claim 2, wherein said hot banana peppers are present in said formulation in a concentration of between about 36.25 and 37.25 per cent by weight.

4. The formulation, according to claim 1, wherein said ketchup is present in said formulation in a concentration of between about 47.5 and 48.7 per cent by weight.

5. The formulation, according to claim 1, wherein said formulation includes hot banana peppers being present in a concentration of between about 20 and 21 percent by weight, said formulation further includes sweet banana peppers being present in a concentration of between about and 15 and 17 per cent by weight.

6. The formulation, according to claim 1, wherein said apple cider vinegar is present in said formulation in a concentration of between about 4.25 and 4.75 percent by weight.

7. The formulation, according to claim 1, wherein said vegetable oil is present in said formulation in a concentration of between about 4.25 and 4.75 percent by weight.

8. The formulation, according to claim 7, wherein said vegetable oil is canola oil.

9. The formulation, according to claim 1, wherein said chopped onions are present in said formulation in a concentration of between 2.1 and about 2.4 per cent by weight.

10. A method for preparing a banana pepper salsa, said method comprising the steps of:
(a) selecting banana peppers before they are red;
(b) washing a predetermined amount of said banana peppers selected in step (a);
(c) drying said banana peppers washed in step (b);
(d) selecting a predetermined amount of onions, garlic and cilantro for said salsa;
(e) chopping said washed and dried banana peppers, said onions, said garlic and said cilantro selected in steps (a) and (d) into pieces having a predetermined size;
(f) placing a predetermined amount of oil into a large pot;
(g) adding a predetermined amount of ketchup to said pot;
(h) mixing said mixture in said pot until said mixture is thoroughly blended;
(i) adding a predetermined amount of vinegar to said pot;
(j) stirring said mixture in said pot frequently;
(k) adding preselected spices to said mixture in said pot;
(j) heating said mixture in said pot to a temperature of between 150 and 175 degrees Fahrenheit;
(l) adding said onions, garlic and cilantro chopped in step (e) into said pot;
(m) adding said peppers chopped in step (e) to said pot;
(n) bringing said mixture in said pot to a slow boil, being sure not to over cook said mixture;
(o) adding a predetermined amount of salt to said mixture in said pot;
(p) stirring said mixture in said pot often until said mixture is slowly boiling;
(q) removing said pot with said salsa blend therein from heat;
(r) placing said salsa blend into heated jars for canning;
(s) sealing said jars with said salsa blend inside; and
(t) allowing said jars sealed in step (t) to cool.

11. The method, according to claim 10, wherein said banana peppers are hot banana peppers.

12. The method, according to claim 10, wherein said banana peppers are a mixture of hot banana peppers and sweet banana peppers.
